(19) United States
(12) Patent Application Publication
(10) Pub. No.: US 2014/0009091 A1
(43) Pub. Date: Jan. 9, 2014

(54) ELECTRIC COMPRESSOR

(71) Applicants: Takashi Kamiya, Kanagawa (JP); Daiho Tsukahara, Kanagawa (JP)

(72) Inventors: Takashi Kamiya, Kanagawa (JP); Daiho Tsukahara, Kanagawa (JP)

(73) Assignee: Panasonic Corporation, Osaka (JP)

(21) Appl. No.: 14/005,854

(22) PCT Filed: Mar. 27, 2012
(86) PCT No.: PCT/JP2012/002119

§ 371 Date: Sep. 18, 2013

(30) Foreign Application Priority Data
Mar. 28, 2011 (JP) 2011-069418

(51) Int. Cl. H02P 31/00

(52) U.S. Cl. CPC H02P 31/00
USPC 318/139

(57) ABSTRACT

A capacitor (114) is provided between a power supply line (111a) and a ground line (111b), which connect a power supply connector (130) connected to a high voltage power supply (140) and a power element (118). A current detection unit (113) for detecting positive current flowing in the direction from the high voltage power supply (140) to the power element (118) and negative current flowing in the opposite direction is provided on the power supply line (111a). A load resistor (112) is provided between the current detection unit (113) and the power supply connector (130). When the current value detected by the current detection unit (113) becomes less than zero, a control unit (116) detects that the connection of the high voltage power supply (140) has released.

### TECHNICAL FIELD

The present invention relates to an electric compressor used for air-conditioning equipment for vehicles.

### BACKGROUND ART

A compressor is a component essential for air-conditioning equipment for a vehicle, and contributes to maintaining comfortable air-conditioning in the vehicle. Examples of the compressor include an engine-driven compressor directly driven by an engine and an electric compressor driven by a motor.

In recent years, vehicles reinforcing environmentally-oriented functions have been actively developed. For example, a function to stop an engine in an idle-state, also known as the idle reduction function is one of the well-known functions. Vehicles equipped with the idle reduction function stop the engines when the vehicles are stopped. Accordingly, if the engine-driven compressors are used, it is difficult to maintain comfortable air-conditioning in the vehicles. The vehicles having the idle reduction function use electric compressors for this reason.

The technique disclosed in PTL 1 is one of the technologies known for the electric compressor. Electric compressor 10 in PTL 1 includes control section 13 controlling current supplied by motor control section 12 that controls driving by motor section 11 to motor section 11, as illustrated in FIG. 1. Control section 13 is connected via power source 14 and harness 15. Electric compressor 10 further includes detecting section 16 detecting that a connection between harness 15 and control section 13 is terminated, that is, that power source 14 is disconnected. Detecting section 16 detects that power source 14 is disconnected when the potential difference of voltage between harnesses 15 applied on control section 13 is smaller than a voltage necessary for a regular operation of motor 11.

Electric compressor 10 according to PTL 1 stores or discharges voltage remaining in capacitor 17 in motor control section that was receiving power supply from power source 14, when detecting section 16 detects that the power source is disconnected for checking or repairing electric compressor 10, for example. With this operation, it is possible to prevent a user from being electrified by the voltage remaining in capacitor 17.

### CITATION LIST

### Patent Literature

PTL 1
Japanese Patent Application Laid-Open No. 2010-96123

### SUMMARY OF INVENTION

### Technical Problem

However, since a large-capacity capacitor is included in an electric compressor, it takes a substantial amount of time to reduce a voltage to a level unable to maintain the regular operation. Stated differently, the problem in electric compressor 10 according to PTL 1 is that it takes too much time to detect that the power source is disconnected.

It is an object of the present invention to provide a compressor capable of reducing the time before detecting that the power source is disconnected, and preventing a user from electrified by voltage remaining in a capacitor.

### Solution to Problem

The electric compressor according to the present invention is an electric compressor including: a power source connecting section detachably attached to a power source; an electric motor that compresses a refrigerant; a power device that converts DC power supplied from the power source to AC power and drives the electric motor; a power line that connects the power source connecting section and the power device, the power line including a power supply line and a ground line; a capacitor having one end connected to the power supply line and the other end connected to the ground line; a current detecting section that is provided on the power supply line closer to the power source connecting section than the capacitor, and detects current flowing from the power source to the power device as one of positive and negative, and current flowing from the power device to the power source as the other of positive and negative; a load resistor that is provided between the current detecting section and the power supply connecting section and that connects the power supply line and the ground line; and a control section that detects that the power source is disconnected from the power source connecting section, when the current detected by the current detecting section flows from the power device to the power source.

### Advantageous Effects of Invention

When the power source is disconnected, the supply of current from the power source to the capacitor is terminated. In response, the capacitor starts discharging the charges stored therein. The charge that is discharged flows to the load resistor. Since the load resistor is provided closer to the power source connecting section than the current detecting section, the direction of the flow of charges toward the load resistor is opposite to the direction of the flow when the power source is connected. According to the present invention, it is possible to detect that the power source is disconnected, based on the direction of current, before a voltage value decreases to a predetermined voltage value. Therefore, it is possible to reduce the time necessary for detecting that the power source is disconnected, and to prevent a user from being electrified by voltage remaining in the capacitor.

### BRIEF DESCRIPTION OF DRAWINGS

FIG. 1 is a block diagram illustrating a configuration of an electric compressor disclosed in PTL 1;

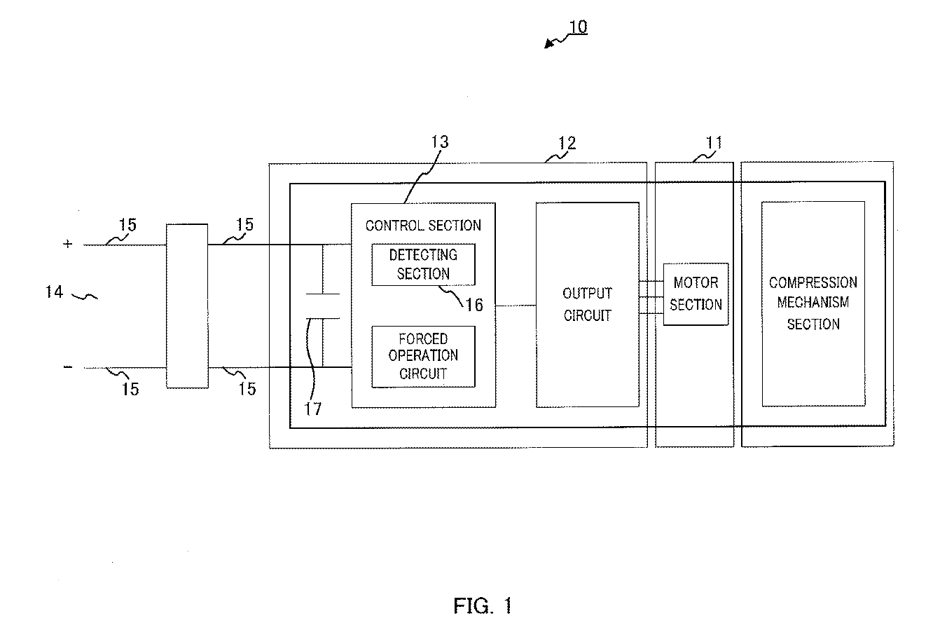

FIG. 2 is a block diagram illustrating a configuration of an electric compressor according to an embodiment of the present invention;

FIG. 3 is a flowchart illustrating a processing order for detecting that a power source is disconnected;

FIG. 4 is a graph illustrating change in current when an electric motor is decelerating, stopped, and disconnected from a power source;

FIG. 5 is a flowchart illustrating a specific processing order for the discharge illustrated in FIG. 3;

FIG. 6 illustrates a change in current and voltage before and after the power source is disconnected; and

FIG. 7 is a block diagram illustrating another configuration of an electric compressor according to an embodiment of the present invention.

### DESCRIPTION OF EMBODIMENTS

Embodiments of the present invention will be described in detail with reference to the accompanying drawings.

### Embodiment

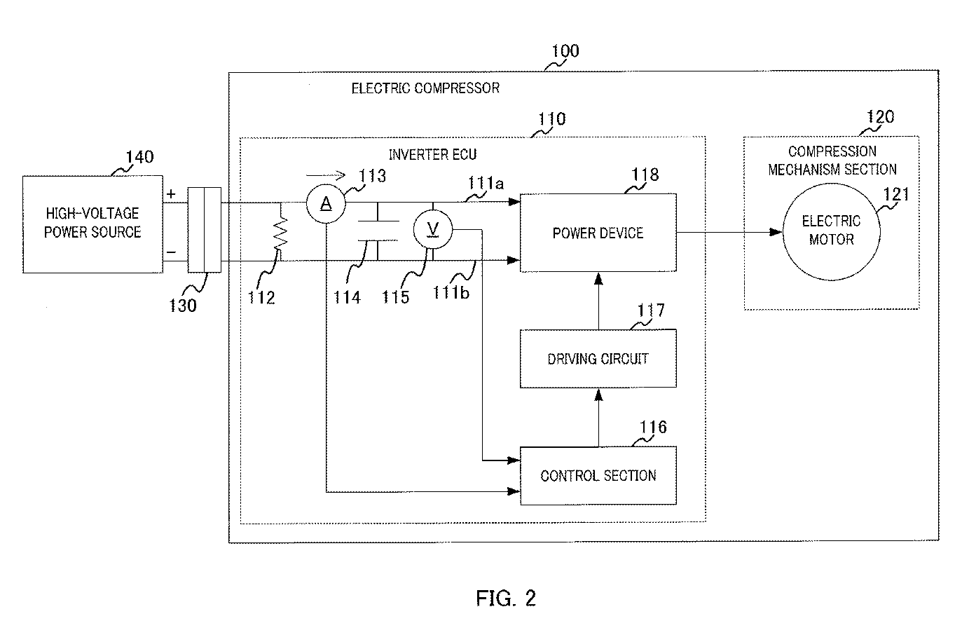

FIG. 2 is a block diagram illustrating a configuration of electric compressor 100 according to an embodiment of the present invention. Electric compressor 100 includes inverter ECU (electronic control unit) 110 and compression mechanism section 120. Inverter ECU 110 is connected to power source connector 130. Power source connector 130 (corresponding to the power source Connecting section) is detachably attached to high-voltage power source 140 that generates DC power (hereafter simply referred to as “power source). Compression mechanism section 120 includes electric motor 121, and compresses a refrigerant by driving electric motor 121.

Inverter ECU 110 includes control section 116, driving circuit 117, and power device 118. Load resistor 112, current detecting section 113, capacitor 114, and voltage detecting section 115 are connected, in order, to power line 111 from the side of the power source connector 130. Power line 111 connects power source connector 130 and power device 118.

Power line 111 includes power supply line 111a and ground line 111b, and supplies DC power generated by power source 140 to power device 118. The voltage of power line ill is approximately 100 V to a few hundreds V, for example.

Load resistor 112 includes load capable of using current that can be detected by current detecting section 113 to be described later, and has one end connected to power supply line 111a, and the other end connected to ground line 111b. The resistance of load resistor 112 is, for example, a few kΩ to several tens of kΩ.

Current detecting section 113 detects current flowing in power supply line 111a from power source connector 130 to power device 118 as positive, and from power device 118 to power source connector 130 as negative, and outputs the current value detected to control section 116.

Capacitor 114 stores the DC power supplied from power source 140, and supplies the stored power to power device 118 as necessary. Capacitor 114 has one end connected to power supply line 111a and the other end connected to ground line 111b. The capacitance of capacitor 114 is approximately several tens of μF to 100 μF, for example.

Voltage detecting section 115 detects a voltage, that is, a potential difference between power supply line 111a and ground line 111b, a voltage between power supply line 111a and ground line 111b connected to power device 118, and outputs the voltage value detected to control section 116.

Control section 116 controls driving circuit 117 so as to start or stop driving electric motor 121. Control section 116 also monitors the current value provided from current detecting section 113, and when the current value is smaller than 0, that is, when current flowing from power device 118 to power source connector 130 is detected, control section 116 detects that power source 140 is disconnected. When control section 116 detects that power source 140 is disconnected, control section 116 instructs driving circuit 117 to forcibly operate electric motor 121 for discharging capacitor 114. When discharging capacitor 114, control section 116 compares the voltage value provided from voltage detecting section 115 to a predetermined threshold. When the voltage value is smaller than or equal to the threshold, control section 116 instructs driving circuit 117 to end the forced operation of electric motor 121.

Driving circuit 117 controls the DC power supplied to power device 118 to be supplied or shut down based on the control by control section 116.

Power device 118 supplies or shuts down the DC power supplied from power source 140 through power line 111, based on the control by driving circuit 117. With this operation, power device 118 converts the DC power to an AC power, and supplies the AC power to electric motor 121.

Electric motor 121 is driven by the AC power supplied from power device 118, and compresses a refrigerant.

When power source connector 130 is disconnected, no current is supplied from power source 140 to capacitor 114. Accordingly, capacitor 114 starts discharging stored charges. The discharged charge flows to load resistor 112. Since load resistor 112 is provided closer to power source connector 130 than current detecting section 113, the flow of charges to load resistor 112 is opposite to the flow when the power source is connected.

As described above, electric compressor 100 includes current detecting section 113 between power source connector 130 and capacitor 114. When power source 140 is disconnected, the disconnection of power source 140 can be immediately detected by detecting current flowing from capacitor 114 to power source connector 130.

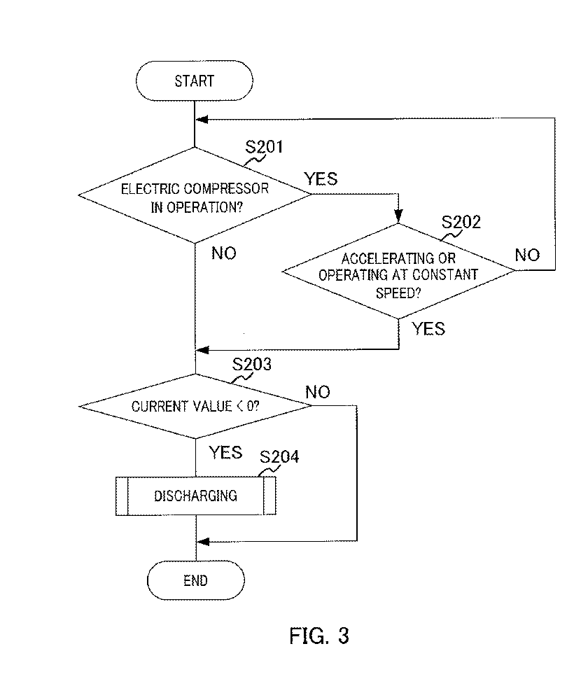

A process by control section 116 illustrated in FIG. 2 for detecting that power source 140 is disconnected will be described with reference to FIG. 3. In FIG. 3, in step S201, control section 116 determines whether or not electric compressor 100 is in operation. When it is determined that electric compressor 100 is in operation (YES), the process proceeds to step S202, and when it is determined that electric compressor 100 is in operation (NO), the process proceeds to step S203.

In step S202, control section 116 determines whether or not an operation status of electric motor 121 is accelerating or in operation at a constant speed. When electric motor 121 is accelerating or operating at a constant speed (YES), the process proceeds to step S203, and when electric motor is not accelerating or operating at a constant speed (NO), that is, when electric motor 121 is decelerating or stopped, the process returns to step S201. It is assumed that control section 116 understands the operation status of electric motor 121.

In step S203, control section 116 determines whether or not a current value detected by current detecting section 113 is smaller than 0. When the current value is smaller than 0 (YES), control section 116 detects that power source 140 is disconnected, and the process proceeds to step S204. When the current value is not smaller than 0 (NO), that is, the current value is greater than or equal to 0, the process for detecting disconnection of power source 140 ends.

In step S204, the charges stored in capacitor 114 are discharged. With this operation, it is possible to prevent a user from being electrified by the voltage remaining in capacitor 114. Specific processes for the discharging process will be described later.

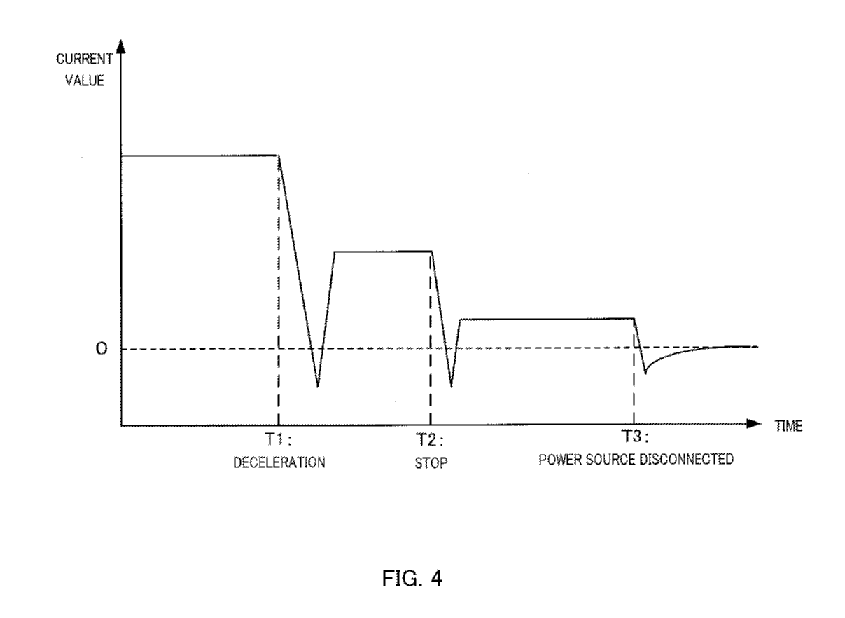

Note that, in step S202, the operation status of electric motor 121 is determined so as to eliminate the possibility of incorrectly determining that the power source is disconnected in step S203, due to regeneration that may occur when electric motor 121 is decelerating or stopped. With regard to this process. FIG. 4 illustrates a change in current when electric motor 121 is decelerating, stopped, and disconnected from the power source. In FIG. 4, the vertical axis denotes current values, and the horizontal axis denotes time. During the deceleration that starts at time T1 and the stopped state that starts at time T2, the current may be smaller than 0. These phenomenon are similar to the disconnection of power source 140 at time 13 in that the current is smaller than 0. Accordingly, the current smaller than 0 due to the decelerating and the stopped state is not suitable for determining the current value in step S203.

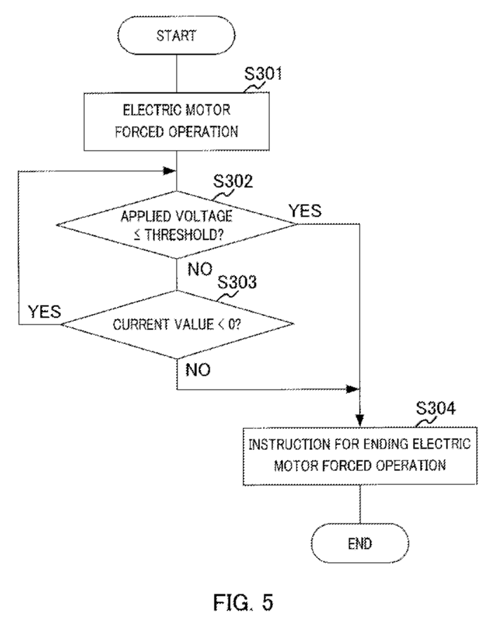

A specific process order for discharging in step S204 illustrated in FIG. 3 will be described with reference to FIG. 5. As a specific example of the discharging, a forced operation of electric motor 121 is used. In FIG. 5, control section 116 instructs driving circuit 117 to forcibly operate electric motor 121 in step S301, such that charges stored in capacitor 114 is released (discharged).

In step S302, control section 116 determines whether or not the voltage between power supply line 111a and ground line 111b detected by voltage detecting section 115 is smaller than or equal to a predetermined threshold. When the voltage is smaller than or equal to the threshold (YES), the process proceeds to step S304, and when the voltage is not smaller than the threshold (NO), the process proceeds to step S303. When the voltage becomes smaller than or equal to a voltage considered as safe, the forced operation (discharging) of electric motor 121 ends.

In step S303, control section 116 determines whether or not a current value detected by current detecting section 113 is smaller than 0. When the current value is smaller than 0 (YES), control section 116 determines that power source 140 is still disconnected, and the process proceeds to step S302 so as to maintain the forced operation of electric motor 121. When the current value is not smaller than 0 (NO), that is, when the current value is larger than or equal to 0, control section 116 determines that power source 140 is reconnected, and the process proceeds to step S304. As described above, in step S303, it is determined whether or not power source 140 is reconnected during the discharging.

In step S304, control section 116 instructs driving circuit 117 to end the forced operation of electric motor 121, and the discharging process ends.

As described above, by performing the discharging process, the charges stored in capacitor 114 is consumed by an electric motor. Accordingly, it is possible to prevent a user from being electrified by the voltage remaining in capacitor 114.

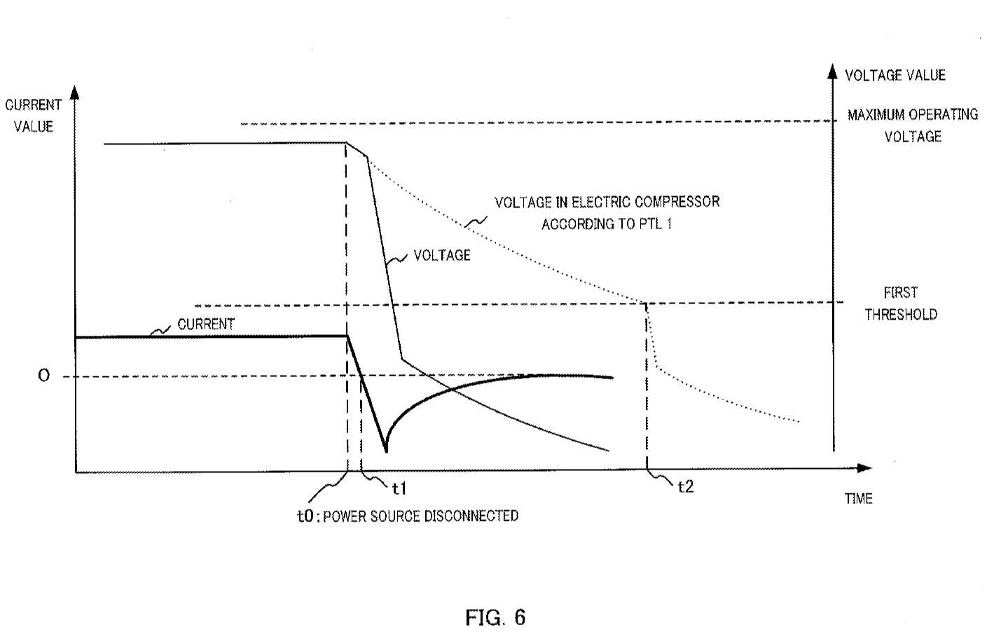

Changes in current and voltage before and after power source 140 is disconnected will be described with reference to FIG. 6. In FIG. 6, the vertical axis on the left denotes current values, the vertical axis on the right denotes voltage values, and the horizontal axis denotes time. The narrow solid line denotes voltage, and the thick solid line denotes current. The dotted line represents voltage in the electric compressor according to PTL 1 for comparison.

FIG. 6 shows that the voltage and current dramatically fall when power source 140 is disconnected at time t0. Electric compressor 10 detects that the power source is disconnected at time t1 when the current value becomes smaller than 0. Accordingly, the time necessary for detecting that the power source is disconnected since the disconnection can be reduced. In contrast, according to the electric compressor disclosed in PTL 1, it was impossible Co detect that the power source is disconnected unless the voltage reaches the first threshold. In addition, since the voltage gradually decreases as shown in the dotted line, the disconnection is detected for the first time at time t2. Therefore, electric compressor 100 can significantly reduce the time necessary for detecting that the power source is disconnected, compared to the electronic compressor disclosed in PTL 1.

As described above, according to the embodiment, a current detecting section that detects current flowing from a power source to a power device as positive current is provided on a power supply line closer to a power source connector than a capacitor provided on the power line connecting a power source connector connected to the power source and the power device. The load resistor is provided between the current detecting section and the power source connector such that the load resistor is directly connected to the power supply line and the ground line. With this configuration, when the power source is disconnected, the current detecting section detects current flowing from the capacitor to the power source connector, disconnection of the power source is detected. Therefore, the time necessary for detecting that the power source is disconnected is reduced.

Note that, in the embodiment, the explanation is made based on an example in which the current detecting section detects the current flowing from the power source connector to the power device is detected as positive current, and current flowing toward the other direction is detected as negative current. However, the present invention not limited to this example, and the current flowing from the power source connector to the power detector may be detected as negative current, and the current flowing in the other direction may be detected as positive current. In this case, the control section detects that the power source is disconnected when a positive voltage value is detected.

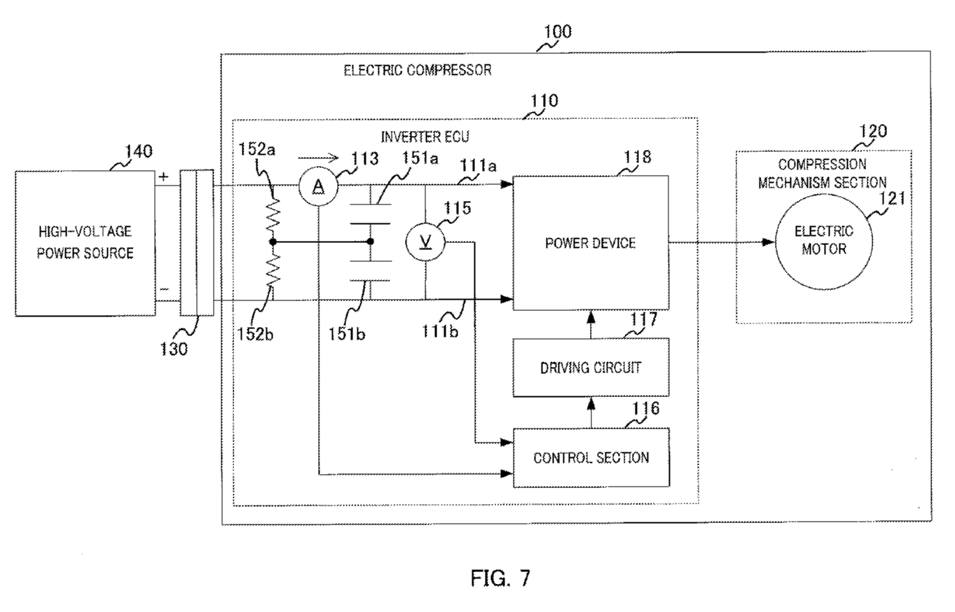

Although a configuration illustrated in FIG. 2 is used for describing the electric compressor in the embodiment, the present invention is not limited to this example. The electric compressor may have a configuration illustrated in FIG. 7. The electric compressor illustrated in FIG. 7 includes two capacitors 151a and 151b having a low breakdown voltage connected in series. Since capacitors having a high breakdown voltage are expensive, connecting inexpensive capacitors in series allows reduction in cost while achieving a desired breakdown voltage at the same time. Here, load resistor 152a and 152b may be intentionally provided so as to evenly apply voltage on the capacitors 151a and 151b connected in series. The load resistors 152a and 152b may consume current discharged from capacitors 151a and 151b. Capacitors 151a and 151b and load resistors 152a and 152b are electrically connected.

However, when load resistor 152 such as a bleeder resistor is provided, note that the components are provided in the following order; load resistor 152, current detecting section 113, and capacitor 151 from the side of power source connector 130, that is, current detecting section 113 is provided between load resistor 152 and capacitor 151, as illustrated in FIG. 7.

Although an example in which two capacitors are connected in series is illustrated in FIG. 7, the number of the capacitors is trot limited to two. The number of the capacitors may be three or more, and three or more capacitors may be connected in series.

The disclosure of Japanese Pat it Application No 2011-069418, filed on Mar. 28, 2011, including the specification, drawings and abstract, is incorporated herein by reference in its entirety.

### INDUSTRIAL APPLICABILITY

The present invention is suitable for electric compressors and others capable of reducing time for detecting that the power source is disconnected, and preventing a user from being electrified by voltage remaining in a capacitor.

### REFERENCE SIGNS LIST

110 Inverter ECU
111 Power line
111a Power supply line
111b Ground line
112, 152, 152a, 152b Load resistor
113 Current detecting section
114, 151, 151a, 151b Capacitor
115 Voltage detecting section
116 Control section
117 Driving circuit
118 Power device
120 Compression mechanism section
121 Electric motor
130 Power source connector
140 High-voltage power source

1. An electric compressor comprising:
a power source connecting section detachably attached to a power source;
an electric motor that compresses a refrigerant;
a power device that converts DC power supplied from the power source to AC power and drives the electric motor;
a power line that connects the power source connecting section and the power device, the power line including a power supply line and a ground line;
a capacitor having one end connected to the power supply line and the other end connected to the ground line;
a current detecting section that is provided on the power supply line closer to the power source connecting section than the capacitor, and detects current flowing from the power source to the power device as one of positive and negative, and current flowing from the power device to the power source as the other of positive and negative;
a load resistor that is provided between the current detecting section and the power supply connecting section and that connects the power supply line and the ground line; and
a control section that detects that the power source is disconnected from the power source connecting section, when the current detected by the current detecting section flows from the power device to the power source.

2. The electric compressor according to claim 1, wherein
when the power source connecting section detects that the power source is disconnected, the control section controls the capacitor such that the capacitor starts discharging charges.

3. The electric compressor according to claim 2, wherein
the control section stops the discharging when a voltage between the power supply line and the ground line connected to the power device is smaller than or equal to a predetermined threshold while the capacitor is discharging.

4. The electric compressor according to claim 2, wherein
the control section stops the discharging when a voltage between the power supply line and the ground line connected to the power device is larger than a predetermined threshold, and when the current detected by the current detecting section flows from the power source to the power device, while the capacitor is discharging.

5. The electric compressor according to claim 1, wherein
the control section determines whether or not the electric compressor is in operation, and when the electric compressor is not in operation, a direction of the current is determined so as to detect that the power source is disconnected from the power source connecting section.

6. The electric compressor according to claim 1, wherein
the control section determines whether an operation status of the electric motor is accelerating or in operation at a constant speed, and determines a direction of the current only when the electric compressor is accelerating or in operation at a constant speed, so as to detect whether or not the power source is disconnected from the power source connecting section.

7. The electric compressor according to claim 1, wherein
the capacitor includes a plurality of capacitors connected in series,
the load resistor includes a plurality of load resistors connected in series, and
the capacitors and the load resistors are electrically connected.
